(19) United States
(12) Patent Application Publication
(10) Pub. No.: US 2026/0111806 A1
(43) Pub. Date: Apr. 23, 2026

(54) BUSINESS AVAILABILITY STATUS INDICATION SYSTEM, METHOD, DEVICE, AND COMPUTER PROGRAM

(71) Applicant: Nicholas Demes Owens, Sarasota, FL (US)

(72) Inventor: Nicholas Demes Owens, Sarasota, FL (US)

(21) Appl. No.: 18/918,459

(22) Filed: Oct. 17, 2024

(51) Int. Cl. G06Q 10/0631

(52) U.S. Cl. CPC G06Q 10/0631

(57) ABSTRACT

Embodiments of the present disclosure provide a system, method, and computer program product for updating and displaying business operating status. The invention comprises a signal generation mechanism, a server, and a data display device connected via a data communication network. The signal generation mechanism, which may be a physical button, a virtual button integrated with an ERP system, a door sensor, or a software-based mechanism, generates an activation signal indicative of business operating status. The server receives this signal, updates the stored status, and transmits it to the display device. The method includes receiving the activation signal, updating the status, and transmitting it for display. The computer program product contains instructions for executing these steps. Additional embodiments include prompting for closing timelines, generating status qualifiers based on scheduled hours, and transmitting updates to multiple third-party platforms.

### FIELD OF INVENTION

The present invention relates to business management systems and methods and more specifically, it pertains to a system, method, and computer program product for real-time updating and displaying of business operating status across multiple platforms. The invention automates the process of communicating business hours and availability to customers through various signal generation mechanisms and display devices.

### BACKGROUND OF THE INVENTION

In today's fast-paced business environment, accurate and real-time information about a business's operating status is crucial for both customers and business owners. The traditional method of displaying business hours through physical signs or online listings often falls short in providing up-to-date information, leading to customer frustration and potential loss of business. Currently, several platforms attempt to address this need by providing business information to customers. These include Google My Business, Apple Maps, Yelp, Facebook Business Pages, Instagram Business Profiles, and website platforms such as Shopify, Squarespace, and Wix. These platforms typically allow business owners to manually input their regular operating hours, with some offering features for temporary closures or special hours.

However, these platforms share common inadequacies. Most require manual intervention to change status, which is often neglected during busy periods or unexpected changes. Updates are not instantaneous and may take hours or even days to reflect across all platforms, leading to inconsistency across different channels. Many platforms don't account for businesses that open early, close late, or have highly variable hours, and there's typically no integration between online status and the actual open/closed status of physical locations.

The state of the art in addressing these issues has several limitations. While some businesses use social media to post real-time updates, this method is inconsistent and requires active engagement from customers. Advanced POS systems can track business activity, but they typically don't integrate with customer-facing platforms. Smart door locks and security systems can detect when a business is open, but this information isn't usually linked to public-facing channels.

Technological solutions available for implementation include Internet of Things (IoT) devices for automated status detection, Application Programming Interfaces (APIs) for real-time data exchange between systems, cloud computing for centralized data management and distribution, mobile technology for on-the-go status updates, and machine learning for predicting operating hours based on patterns. However, these technologies have not been effectively integrated into a comprehensive solution for business hour management and communication.

The inadequacies of current systems often lead to scenarios where customers travel to businesses only to find them unexpectedly closed or not yet open. This results in wasted time and resources for customers, and potential loss of goodwill and business for the establishments. Moreover, businesses with irregular hours or those that frequently adjust their schedules based on demand or other factors find it challenging to keep their customers accurately informed.

Small businesses and those with informal operating structures face particular challenges. They may lack the resources or technical knowledge to consistently update multiple online platforms. Additionally, businesses in dynamic environments, such as food trucks or pop-up shops, struggle to communicate their constantly changing locations and hours effectively.

It is, therefore, an object of the present invention to address these inadequacies by providing a comprehensive system, method, and computer program product for real-time updating and displaying of business operating status. The invention aims to automate the process of status updates, ensure consistency across multiple platforms, and provide flexibility for businesses with variable operating hours. By integrating physical status indicators with digital platforms, the invention seeks to bridge the gap between the physical store environment and online information sources. Ultimately, the goal is to improve the accuracy of business hour information, enhance customer experience, and increase operational efficiency for businesses of all sizes and types.

### SUMMARY OF THE INVENTION

Embodiments of the present disclosure may include a system for updating and displaying business operating status, including a signal generation mechanism configured to generate an activation signal indicative of a business operating status. Embodiments may also include a data communication network operatively connected to the signal generation mechanism.

Embodiments may also include at least a server operatively connected to the data communication network and configured to receive the activation signal from the signal generation mechanism via the data communication network. Embodiments may also include update a stored business operating status based on the received activation signal. Embodiments may also include transmit the updated business operating status. Embodiments may also include a data display device operatively connected to the server and configured to receive the updated business operating status from the server. Embodiments may also include display the updated business operating status.

In some embodiments, the signal generation mechanism may include a physical button located at the business premises. In some embodiments, the signal generation mechanism may include a virtual button integrated with an Enterprise Resource Planning (ERP) system, configured to send an active status signal when the ERP system may be in use, indicating the business may be open. Embodiments may also include send no signal when the ERP system may be not in use, indicating the business may be closed.

In some embodiments, the signal generation mechanism may include a door sensor configured to automatically send an open status signal when the door may be opened. Embodiments may also include automatically send a closed status signal when the door may be closed. In some embodiments, the signal generation mechanism may be further configured to prompt for a closing timeline, allowing input of a predetermined time period before the business status changes to closed.

In some embodiments, the server may be further configured to initiate a countdown based on the predetermined time period. Embodiments may also include automatically update the business operating status to closed when the countdown reaches zero. In some embodiments, the data display device may include a plurality of third-party platforms, each configured to display the updated business operating status.

In some embodiments, the server may be further configured to store scheduled business operating hours. Embodiments may also include compare the received activation signal with the scheduled business operating hours. Embodiments may also include generate a status qualifier based on the comparison, the status qualifier being one of “open early”, “open late”, “opening late”, “closing late”, “closing early”, “closed early”, or similar phrases used to indicate opening or closing differently than expected based on operating hours. Embodiments may include changing business operating status back to simply “Open” or “Closed” after a period of time occurs or, when applicable, when the regular business operating hours are reached.

Embodiments of the present disclosure may also include a method for updating and displaying business operating status, including receiving, at a server, an activation signal indicative of a business operating status via a data communication network. In some embodiments, the activation signal may be generated by a signal generation mechanism selected from a group including a physical button located at the business premises.

Embodiments may also include a virtual button integrated with an Enterprise Resource Planning (ERP) system. Embodiments may also include a door sensor configured to automatically detect door opening and closing. Embodiments may also include a software-based activation mechanism on a business computing device. Embodiments may also include updating, by the server, a stored business operating status based on the received activation signal. Embodiments may also include transmitting, by the server, the updated business operating status to a data display device. Embodiments may also include displaying, by the data display device, the updated business operating status.

In some embodiments, the method may include prompting, by the signal generation mechanism, for a closing timeline input. Embodiments may also include receiving a predetermined time period for the closing timeline. Embodiments may also include initiating a countdown based on the predetermined time period.

In some embodiments, the method may include automatically updating the business operating status to closed when the countdown reaches zero. In some embodiments, the method may include storing, at the server, scheduled business operating hours. Embodiments may also include comparing the received activation signal with the scheduled business operating hours.

Embodiments may also include generating a status qualifier based on the comparison. In some embodiments, the status qualifier may be one of “open early”, “open late”, “opening late”, “closing late”, “closing early”, “closed early”, or similar phrases used to. indicate opening or closing differently than expected based on operating hours. In some embodiments, the data display device may include a plurality of third-party platforms, and the method may include transmitting the updated business operating status to each of the plurality of third-party platforms. In some embodiments, the status qualifier or updated business operating status may be sent to an intermediary server and that intermediary server may relay the status qualifier or updated business operating status to the plurality of third-party platforms.

Embodiments may also include when the signal generation mechanism may be the virtual button integrated with the ERP system, the method may include sending an active status signal when the ERP system may be in use, indicating the business may be open. Embodiments may also include sending no signal when the ERP system may be not in use, indicating the business may be closed.

Embodiments of the present disclosure may also include a computer program product for updating and displaying business operating status, the computer program product including a computer readable storage medium having program instructions embodied therewith, the program instructions executable by a processor to cause the processor to perform a method including receiving an activation signal indicative of a business operating status via a data communication network.

In some embodiments, the activation signal may be generated by a signal generation mechanism selected from a group including a physical button located at the business premises. Embodiments may also include a virtual button integrated with an Enterprise Resource Planning (ERP) system. Embodiments may also include a door sensor configured to automatically detect door opening and closing.

Embodiments may also include a software-based activation mechanism on a business computing device. Embodiments may also include updating a stored business operating status based on the received activation signal. Embodiments may also include transmitting the updated business operating status to a data display device. Embodiments may also include causing the data display device to display the updated business operating status.

In some embodiments, the method may include prompting for a closing timeline input. Embodiments may also include receiving a predetermined time period for the closing timeline. Embodiments may also include initiating a countdown based on the predetermined time period. Embodiments may also include automatically updating the business operating status to closed when the countdown reaches zero.

In some embodiments, the method may include storing scheduled business operating hours. Embodiments may also include comparing the received activation signal with the scheduled business operating hours. Embodiments may also include generating a status qualifier based on the comparison, the status qualifier being one of “open early”, “open late”, “opening late”, “closing late”, “closing early”, “closed early”, or similar phrases used to indicate opening or closing differently than expected based on operating hours. Embodiments may also include transmitting the status qualifier along with the updated business operating status.

In some embodiments, the method may include detecting a plurality of third-party platforms configured to display the business operating status. Embodiments may also include transmitting the updated business operating status to each of the detected plurality of third-party platforms. Embodiments may also include when the signal generation mechanism may be the virtual button integrated with the ERP system, the method may include monitoring usage of the ERP system. Embodiments may also include sending an active status signal when the ERP system may be detected to be in use, indicating the business may be open. Embodiments may also include sending no signal when the ERP system may be detected to be not in use, indicating the business may be closed.

### BRIEF DESCRIPTION OF THE DRAWINGS

The novel features believed to be characteristic of the illustrative embodiments are set forth in the appended claims. The illustrative embodiments, as well as a preferred mode of use, will best be understood by reference to the following detailed description when read in conjunction with the accompanying drawings, wherein:

FIG. 1A illustrates a conventional methodology for communicating business operating status, according to one embodiment.

FIG. 2A illustrates a prior art system for managing and displaying business operating hours and assumed business operating status on the Internet.

FIG. 3A illustrates a novel system for updating and displaying business operating status, addressing the limitations of prior art methods.

FIG. 4A illustrates a sensor-based system for automatically updating and displaying business operating status.

FIG. 5A illustrates a software-based system for automatically updating and displaying business operating status.

FIG. 6A 6B, 6C, 6D, 6E, and 6F illustrate the display of business operating status, according to various embodiments of the present invention.

FIGS. 7A and 7B illustrate a signage device for displaying and communicating business operating status according to various embodiments of the present invention.

FIG. 8A is a flowchart illustrating a method for updating, according to some embodiments of the present disclosure.

FIG. 9A is a flowchart further illustrating the method for updating from FIGS. 8A, according to some embodiments of the present disclosure.

FIG. 10A is a flowchart further illustrating the method for updating from FIG. 1A, according to some embodiments of the present disclosure.

FIG. 11A is a flowchart further illustrating the method for updating from FIGS. 7A and 7B, according to some embodiments of the present disclosure.

### DETAILED DESCRIPTION OF PREFERRED EMBODIMENTS

It is to be understood that the form of the invention shown and described herein is to be taken as a preferred embodiment of the present invention. However, it does not express the full technical spirit and scope of this invention. Accordingly, it should be understood that various changes and modifications may be made to the invention without departing from its spirit and scope.

The present disclosure describes a system enabling efficient and accurate management of business hour communication in various commercial settings. Embodiments of the system, method, and computer program product may be physically implemented leveraging computerized automation for elements of status detection, information updating, and multi-platform communication. Alternatively, the system format could flexibly facilitate predominantly manual rollout within business guidelines while still utilizing key technological components.

In general, the disclosed system comprises a network of signal generation mechanisms, a central processing server, and user interface devices that work together to streamline the status update process. The system encourages broad applicability across many types of businesses by providing flexible detection methods and customizable status management. The integration of advanced technologies provides significant incentives for businesses to adopt this system, improving communication efficiency and customer satisfaction.

The digital tracking of business status enables oversight and continuity across various stages of the operating day, spanning from opening detection to closing communication. Standardization of key operational parameters; such as automatic status updates and real-time communication, creates consistent and efficient processes across different business settings. Optimal configurations for the system structure are determinable through simulation modeling and variables analysis.

The detailed description provided hereafter explores the system architecture, modules, and information flows facilitating the operation of the system in accordance with the phases of the disclosed format. Both hardware implementations and software components are discussed, highlighting the system's versatility and adaptability to various business needs.

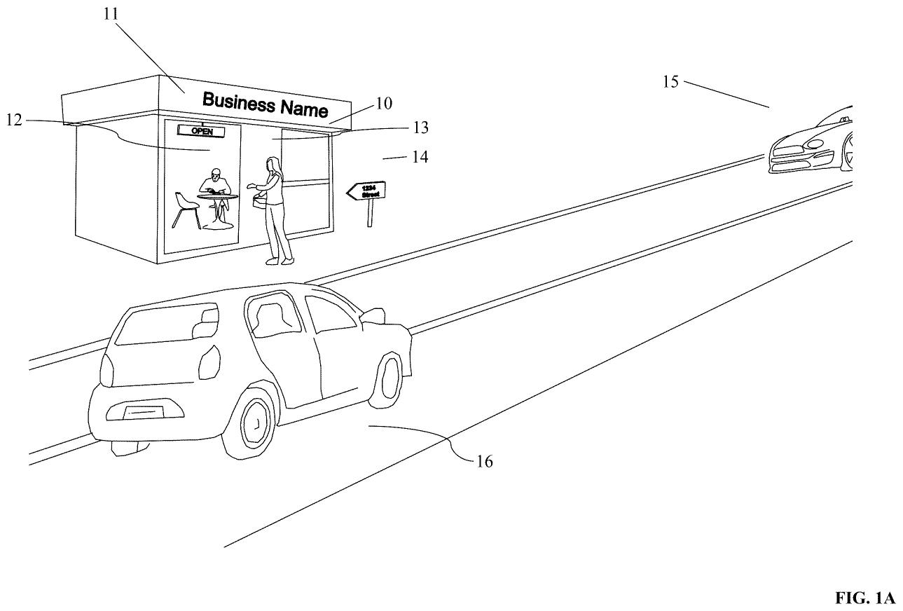

The embodiment of FIG. 1A illustrates the conventional methodology for communicating business operating status. The figure depicts a business premise 10 where goods or services are provided. At the entrance of the premise, an open/closed sign 11 is visible, serving as the primary indicator of the business's current operating status. Inside the premise, a business person 12 is present, preferably representing the staff responsible for managing the establishment's hours. A customer 13 is shown at the entrance, symbolizing the immediate verification of the business's status that on-site visitors can obtain. The business's physical address 14 is also displayed, emphasizing the location-based nature of traditional operating hour communication. In the distance, a vehicle 15 is visible, potentially rushing to reach the business before closing hours. This illustration underscores the uncertainty faced by customers who are not physically present at the location and must rely on potentially outdated information about operating hours. The street 16 where the business is located is also shown, providing context for the physical environment and accessibility of the premise. This prior art methodology relies heavily on physical presence and visual confirmation of operating status, leading to inefficiencies for both businesses and customers. It fails to address the needs of modern consumers who seek real-time, remotely accessible information about business hours, especially in cases of unexpected changes or irregular operating schedules.

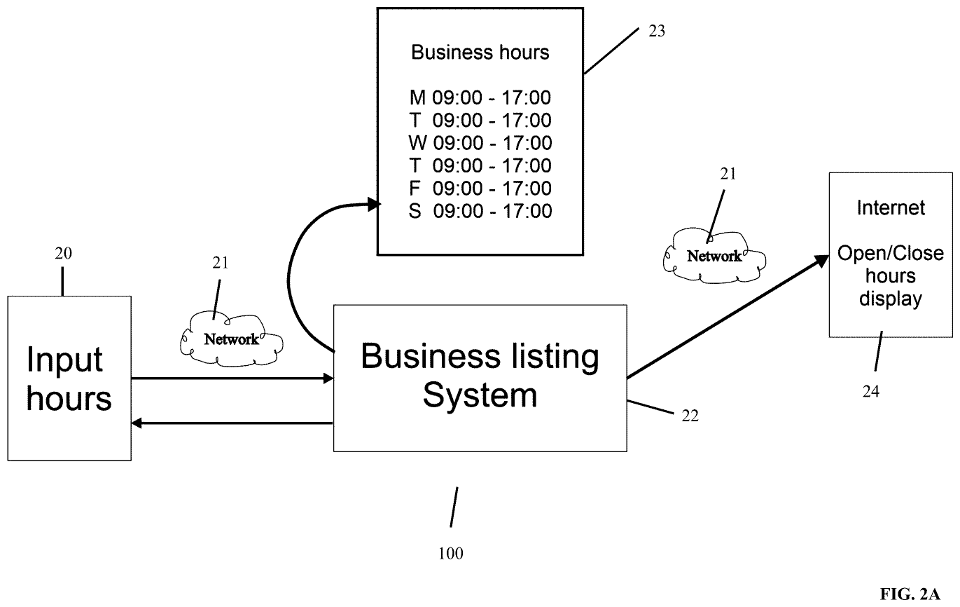

Reference is now made to FIG. 2A, which illustrates a prior art system 100 for managing and displaying business operating hours. The process begins with a business operating hours/availability input device or system 20, typically a computer or mobile device where business owners manually enter their hours of operation. This information is then transmitted via a data communication network 21, such as the internet, to at least one business listing system 22. These systems may include popular platforms like Google My Business and Apple Maps, which aggregate and display business information for public access. The business operating data 23 typically shows standard operating hours, for example, Monday to Friday 9 AM to 5 PM, and Saturday 10 AM to 3 PM. This information is then made available on internet-accessible displays 24, such as smartphones, tablets, or computers, allowing customers to view the operating hours from any location. While this system represents an improvement over purely physical signage, it has significant limitations. The data is often static and doesn't reflect sudden changes in schedule. Updates to operating hours frequently require approval processes, leading to delays in reflecting accurate information. Moreover, the system relies on manual input and doesn't automatically adjust for unexpected closures or extended hours, potentially leading to customer frustration when faced with inaccurate information.

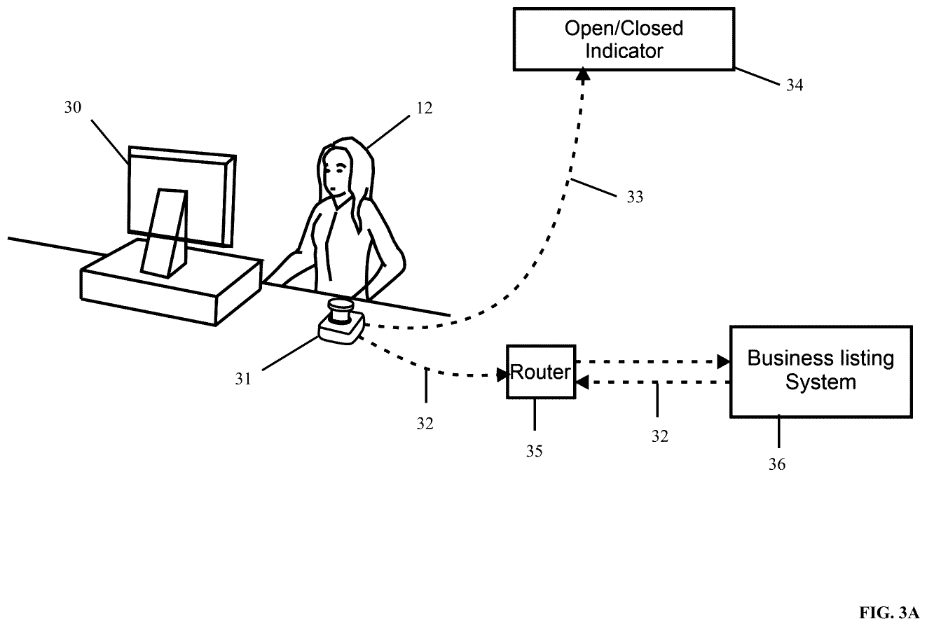

The non-limiting embodiment of FIG. 3A illustrates a system for updating and displaying business operating status, addressing the limitations of prior art methods. One aspect of the system is a business computer 30 located at the business premises, operated by a business person 12. Also illustrated in this figure is a button or interface 31 that allows real-time confirmation of the business's open/close status. Preferably, the button can be toggled between open and closed states, and in some aspects, with additional options for pending closure or pending opening, providing nuanced status updates. When activated, the button communicates its state via a data communication network 32 to the business listing server/system. This communication can occur through various means, such as APIs, webhooks, SDKs, or other automated protocols, ensuring rapid and reliable data transmission. In this aspect, simultaneously, the button activation triggers a signal/data communication 33 to an in-premise open or closed indicator 34. This indicator, which could be an LED sign, color-changing light, or digital display, provides immediate visual feedback within the business premises. Preferably, the system utilizes a router 35, preferably an internet router, to facilitate internet-based data transmission. Other examples of data transmission methods could include cellular networks, satellite communications, or dedicated business networks, offering flexibility for various business environments. The updated status is then reflected in real-time on business listing systems 36 such as Google My Business or Apple Maps. These platforms can now provide instantaneous updates to users, significantly improving the accuracy of business availability information. This system's real-time capability and ease of use represent a substantial improvement over static, manually updated systems, addressing the critical need for accurate, up-to-the-minute business operating status across multiple platforms.

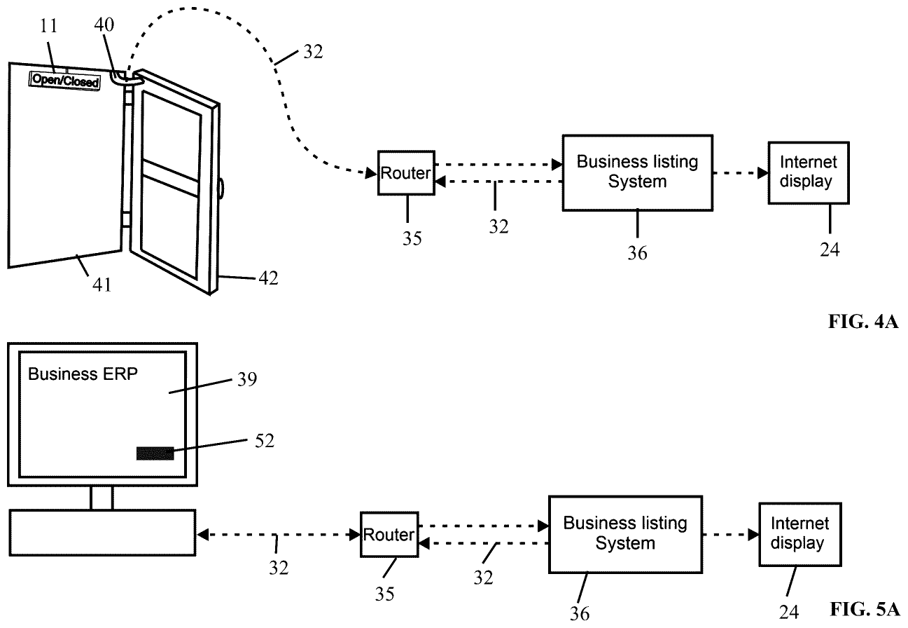

Further reference is made to FIG. 4A which illustrates a sensor-based system for automatically updating and displaying business operating status, further advancing the mechanisms introduced in FIG. 3A. At the business premise, an open/closed sign 11 is still present, but its function is now augmented by a sensor 40 installed at the business entrance 41. This sensor is calibrated to detect the opening and closing of the door 42, automatically transmitting this data to update the business's operating status. The sensor is connected to the system via API, webhook, SDK, or other automated means, ensuring rapid and reliable data transmission. When the door opens or closes, triggering the sensor, this information is communicated through a data communication network 32 to the business listing server/system. Preferably, the network utilizes a router 35, preferably an internet router, for internet-based data transmission. Alternative transmission methods could include cellular networks, satellite communications, or dedicated business networks, providing flexibility for various business environments. The updated status is then reflected in real-time on business listing systems 36 such as Google My Business or Apple Maps. These platforms can now provide instantaneous, automated updates to users without any manual intervention from the business owner. The current operating status is then displayed on internet-available displays 24 such as smart-phones, laptops, or tablets, allowing customers to access this information from any location. This real-time, sensor-based system offers significant advantages over previous methods. It eliminates the need for manual updates, reducing human error and ensuring that the displayed status always matches the actual state of the business. The automatic nature of the updates means that even unexpected openings or closures are immediately reflected across all platforms, greatly improving the accuracy and reliability of business operating information for customers.

On the other hand, the FIG. 5A illustrates an advanced, software-based system for automatically updating and displaying business operating status, further refining the concepts introduced in previous figures. One aspect of this system is a business computer or other electronic device 39 equipped with specialized business software. This software may be designed to automatically transmit business open data when the device is detected within the business location, leveraging technologies such as GPS or Wi-Fi positioning for location verification. To provide additional control and flexibility, the system incorporate's a virtual button 52 integrated into the business software interface. This virtual button may allow manual override or confirmation of the automatic status updates, ensuring accuracy in cases where the business might be open but the authorized device is not present, or vice versa. When either the automatic detection or the virtual button activation occurs, the status update is communicated through a data communication network 32 to the business listing server/system. This communication may be facilitated through various means such as APIs, webhooks, SDKs, or other automated protocols, ensuring swift and reliable data transmission. As before, the system utilizes a router 35, preferably an internet router, for internet-based data transmission. Alternative transmission methods could include cellular networks, satellite communications, or dedicated business networks, offering flexibility for diverse business environments. The updated status is then reflected in real-time on business listing systems 36. These platforms can now provide instantaneous, automated updates to users, significantly improving the accuracy of business availability information. The current operating status is then displayed on internet-available displays 24 such as smartphones, tablets, or computers, allowing customers to access this real-time information from any location. This software-based system offers substantial advantages, combining the benefits of automatic detection with the option for manual control. It reduces the likelihood of human error in status updates while still allowing for human oversight, ensuring that the displayed status always accurately reflects the actual state of the business. The real-time nature of the updates means that even unexpected changes in business hours are immediately reflected across all platforms, greatly enhancing the reliability of business operating information for customers and potentially increasing customer satisfaction and foot traffic.

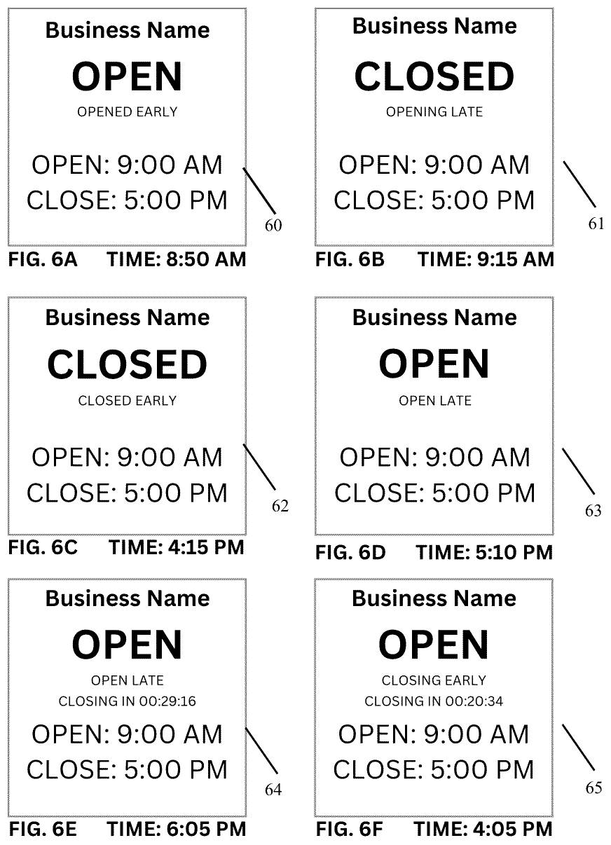

In one aspect, the FIG. 6A illustrates a business status display showing the business name along with an “Opened Early” status 60. This status update goes beyond the simple “Open” or “Closed” dichotomy, providing customers with more nuanced information. The “Opened Early” status could be triggered by various scenarios enabled by the new system. For instance, a business owner might arrive earlier than usual and decide to open before the scheduled time. Using a virtual button, physical button, physical switch, sensor-based detection, or other method, they can easily update the status to reflect this early opening. This could be particularly useful for businesses that experience fluctuating customer demand or those looking to capitalize on unexpected foot traffic, such as a café opening early on a surprisingly busy morning.

In a further aspect, the FIG. 6B displays a business name with an “Opening Late” status 61, another nuanced update made possible by the new system. This status provides valuable information to customers who might be planning to visit the business at its regular opening time. The “Opening Late” status could be triggered by various circumstances. For example, if a delivery is running late or if there's an unexpected staff shortage, the business owner can use the system to quickly update the status. This could be done via the virtual button on their business software, or it might be automatically triggered if the system detects that the business devices or sensors haven't been activated by the usual opening time. By providing this real-time update, the business can manage customer expectations and reduce potential frustration.

Even further, the FIG. 6C shows a business name with a “Closed Early” status 62, demonstrating the system's ability to handle unexpected changes in business hours, This status update could be triggered by several situations. For instance, if a business experiences an equipment failure, runs out of stock earlier than expected, or needs to close for an emergency, the owner can quickly update the status using the system's interface. Alternatively, if the system is set up with sensors, it might automatically update to “Closed Early” if it detects that the business has shut down operations before the scheduled closing time. This real-time update helps prevent customers from making unnecessary trips to a closed business, thereby improving customer satisfaction.

Further still, the FIG. 6D illustrates a business name with an “Open Late” status 63, showcasing the system's flexibility in handling extended business hours. This status could be triggered when a business decides to stay open beyond its regular hours, perhaps due to high customer demand or a special event. The business owner could use the virtual button in their software to update the status, or if the system is sensor-based, it might automatically maintain the “Open” status beyond the usual closing time, updating it to “Open Late” to inform customers of the extended hours. This feature is particularly useful for businesses with fluctuating closing times, such as restaurants on busy nights or retail stores during holiday seasons, allowing them to capitalize on additional business opportunities while keeping customers informed.

On the other hand, the FIG. 6E illustrates a business status display showing the business name along with an “Open Late” status 64 and a countdown indicating to customers that the business will be closing soon but not immediately. In the context of our innovative system, it represents a real-time, verified status, that offers significant advantages over traditional static displays including that the business is open later than their regular hours suggest but also, crucially, that there may still be time to get to the business before they intend to close. Moreover, the system's ability to broadcast this status and countdown across various platforms (such as Google My Business, Apple Maps, or the business's own website ensures consistency of information, enhancing customer trust and satisfaction.

The FIG. 6F illustrates a business status display showing the business name along with a “Closing Early” status 65 and a countdown indicating to customers that the business will be closing soon but not immediately. Similar to FIG. 6E, this nuanced and innovative display will help prevent customers from wasting time on an unnecessary trip and build goodwill with customers.

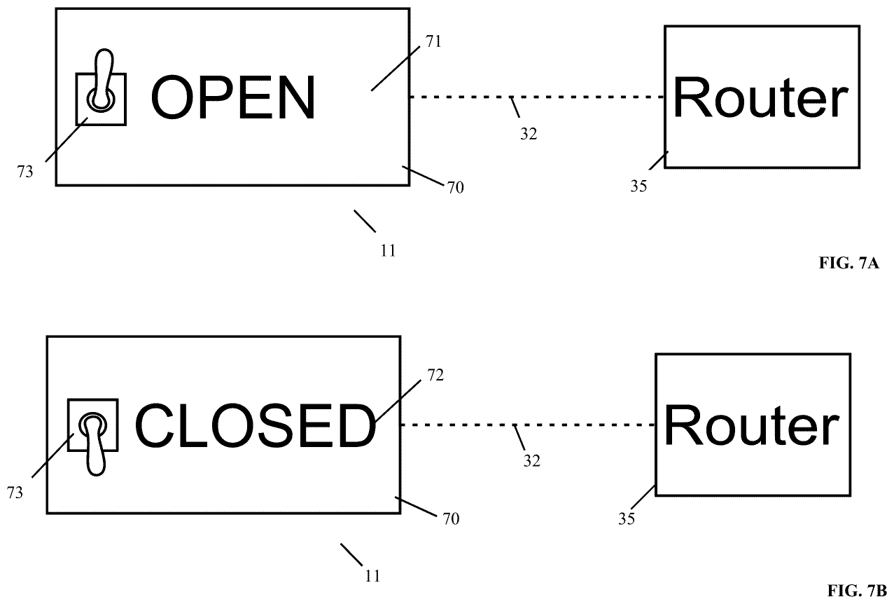

In another non-limiting aspect, the FIG. 7a and FIG. 7b describe a signage device 11 for displaying and communicating business operating status, comprising a housing 70, a display area integrated with the housing, the display area configured to alternately show “Open” status 71 and “Closed” status 72. Further, a manual switch mechanism 73 is physically integrated with the housing with the switch mechanism having at least two positions corresponding to “Open” and “Closed” states. The signage device may further comprise a power interface configured to connect to a power source, the power source being selected from either a plug-in electrical connection and a battery, although other power sources may be also anticipated, e.g. solar, wind, motors, charged capacitors among others. Preferably, the signage device may comprise a control unit disposed within the housing and operatively connected to the switch mechanism and the display area, the control unit being configured capable of changing the display area from “Closed” to “Open” or from “Open” to “Closed” in response to actuation of the switch mechanism.

In further aspects, there may be disposed a communication module disposed within the housing and operatively connected to the control unit being provided to establish a wired or wireless connection 32 with one or more remote servers associated with third-party listing websites or applications, for example through the illustrated router 35, to transmit, preferably in real-time, an “Open” signal to the one or more remote servers when the switch mechanism is actuated to the “Open” position or a “Closed” signal to the one or more remote servers when the switch mechanism is actuated to the “Closed” position. In a preferred aspect, the signage device may be configured such that actuation of the switch mechanism simultaneously changes the display on the display area and triggers the transmission of the corresponding status signal to the one or more remote servers.

In some aspects the manual switch mechanism may comprise a physical switch integrated with the housing of the device, a digital toggle implemented as a touchscreen interface or a software button on a connected computing device. In some aspects, the touchscreen interface may permit the employee to schedule closing at a specified time (which may be displayed as a countdown), control the text of the status qualifier message, and update operating hours.

In other aspects, the manual switch mechanism may comprise a physical switch integrated with a separate control unit within a housing and operatively connected to the control unit within the device housing via a wired or wireless connection.

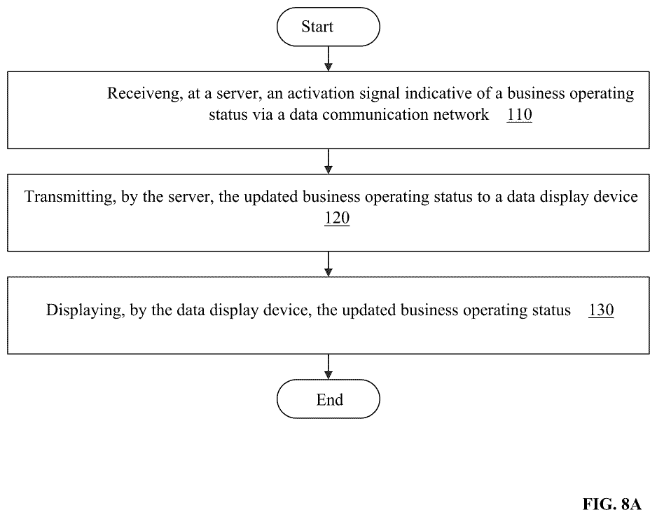

FIG. 8A is a flowchart that describes a method for updating, according to some embodiments of the present disclosure. In some embodiments, at 110, the method may include receiving, at a server, an activation signal indicative of a business operating status via a data communication network. At 120, the method may include transmitting, by the server, the updated business operating status to a data display device. At 130, the method may include displaying, by the data display device, the updated business operating status.

In some embodiments, the activation signal may be generated by a signal generation mechanism selected from a group comprising, a physical button located at the business premises, a virtual button integrated with an Enterprise Resource Planning (ERP) system, a door sensor configured to automatically detect door opening and closing, or a software-based activation mechanism on a business computing device. The method may include transmitting the updated business operating status to each of the plurality of third-party platforms or it may include to a single server which is responsible for may be sent directly to Google Local directly or the updated business operating status may be sent to a server which is responsible for relaying the updated business operating status to Google Local as well as any and all other displays for the business which have been previously connected by the business or connected for the business.

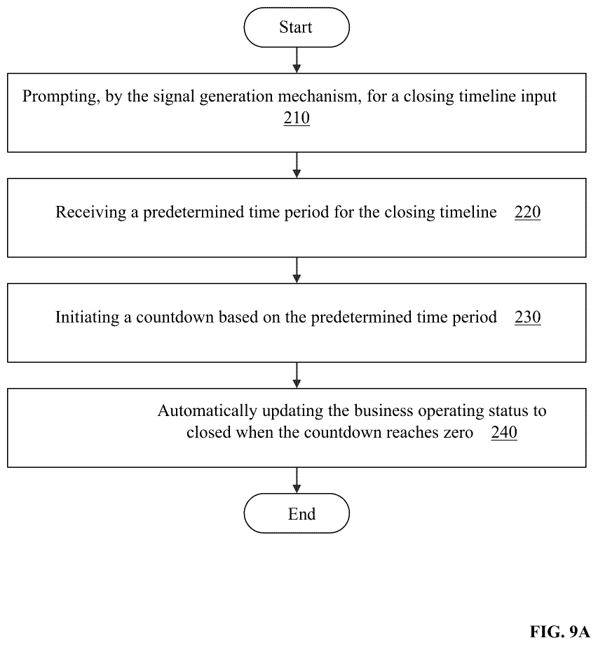

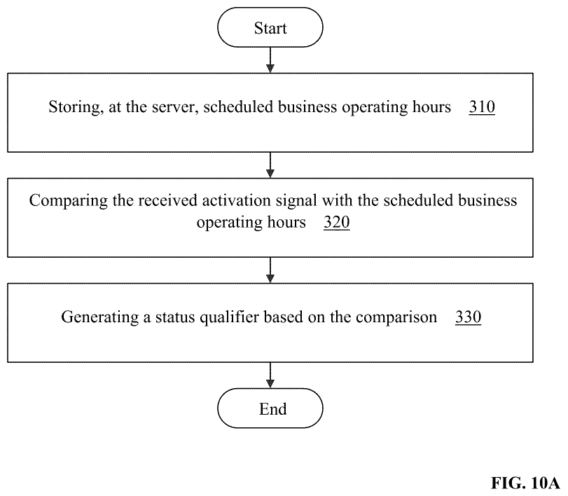

FIG. 9A is a flowchart that further describes the method for updating from FIG. 8A, according to some embodiments of the present disclosure. In some embodiments, at 210, the method may include prompting, by the signal generation mechanism, for a closing timeline input. At 220, the method may include receiving a predetermined time period for the closing timeline. At 230, the method may include initiating a countdown based on the predetermined time period. In some embodiments, at 240, the method may include automatically updating the business operating status to closed when the countdown reaches zero.

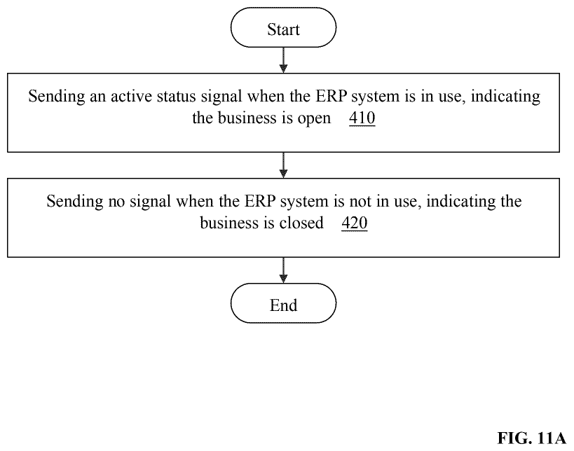

FIG. 10A is a flowchart that further describes the method for updating from FIG. 1A, according to some embodiments of the present disclosure. In some embodiments, at 310, the method may include storing, at the server, scheduled business operating hours. At 320, the method may include comparing the received activation signal with the scheduled business operating hours. At 330, the method may include generating a status qualifier based on the comparison. In some embodiments, the status may qualifier may be one of “open early”, “open late”, “opening late”, “closing late”, “closing early”, “closed early”, or similar phrases used to indicate opening or closing differently than expected based on operating hours. The method may include performing one or more additional steps.

FIG. 11A is a flowchart that further describes the method for updating from FIG. 7A and FIG. 7B, according to some embodiments of the present disclosure. In some embodiments, when the signal generation mechanism may be the virtual button integrated with the ERP system. At 410, the method may include sending an active status signal when the ERP system may be in use, indicating the business may be open. At 420, the method may include sending no signal when the ERP system may be not in use, indicating the business may be closed.

In some aspects, the system may include a customer subscription feature that allows individuals to receive real-time updates about the operating status of specific businesses they are interested in. In an exemplary aspect, the subscription process begins when a customer, using a mobile app or web interface, sends a request to the system's remote server to follow or subscribe to status updates for a particular business. This request might be triggered by the customer selecting a “Follow”or “Subscribe”button on the business's profile within the app or website. The remote server then stores this customer's information along with their subscription preferences in a secure database. This database maintains a record of which customers are subscribed to updates from which businesses, allowing for efficient management of the notification system.

As an example, when the open/closed sign device at a business premises transmits a status update signal—for instance, when the business opens or closes—this signal is received by the remote server. The server then cross-references the received status update with its database of customer subscriptions. It identifies all customers who have opted to receive updates from that specific business.

For each identified customer, the server generates a personalized notification message. This message would typically include the name of the business, its current operating status (e.g., “Now Open” or “Just Closed”), and possibly additional information such as the time of the status change or the business's location. The server then transmits these notification messages to the subscribed customers. Depending on the system's capabilities and user preferences, these notifications could be delivered through various channels, such as push notifications on a mobile app, SMS text messages, or emails.

While the descriptions and figures showcase specific configurations of signal generation mechanisms for detecting and communicating business operating status, a variety of additional or alternative technologies may be incorporated in embodiments for this purpose without departing from the spirit of the business operating status update system concepts. Other status detection and communication options applicable to the system include, but are not limited to, motion sensors for detecting business activity, thermal imaging for occupancy detection, power consumption monitoring, Wi-Fi network activity analysis, computer vision with deep learning for analyzing business activity patterns, acoustic sensors for detecting ambient noise levels indicative of business operations, and other demonstrated methods that provide reliable detection and communication of business operating status. These allow the server to derive accurate business status information through various means, whether based on electromagnetic, optical, acoustic, or other properties amenable to business environment installation, durability, and computational interpretation.

One alternative embodiment could incorporate predictive analytics to anticipate and suggest status updates. This enhancement may utilize machine learning algorithms to analyze historical data of the business's operating patterns, including factors such as weather conditions, local events, and seasonal trends. For instance, if the system detects that the business typically opens later on rainy days or closes early on slow business days, it could proactively suggest these status changes to the business owner. The owner could then have the option to confirm or override these suggestions with a single click. This predictive feature could help businesses maintain more accurate status information even when they forget to update it manually, further improving the reliability of the system.

Another alternative embodiment could integrate voice activation technology, allowing business owners to update their status through voice commands. This hands-free option could be particularly beneficial in environments where touching a device or button is impractical, such as in food service or medical settings. The system could be configured to respond to specific voice commands like “Hey [System Name], we're opening early today” or “Hey [System Name], we need to close in 30 minutes.” These voice commands could be processed through a smart speaker placed in the business premises or through a mobile app on the owner's smartphone, providing flexibility and ease of use in various business scenarios.

Another alternative embodiment could introduce a customer-facing feedback loop to enhance the accuracy of status information. In this version, customers who arrive at the business location could have the option to confirm or dispute the current status through a mobile app or QR code scan. For example, if a customer arrives at a business that is displayed as “Open” but finds it closed, they could quickly report this discrepancy. The system could then temporarily flag the status as “Potentially Closed” until verified by the business owner. This crowdsourced verification could help catch and correct errors quickly, especially in cases where the business might have forgotten to update their status or where there's a malfunction in the automated system.

Another alternative embodiment could include more detailed status information beyond just open or closed. For instance, it could incorporate real-time capacity data for businesses like restaurants or gyms. Using occupancy sensors or integration with point-of-sale systems, the. status could display information like “Open—75% Full” or “Open—Short Wait.” For service-based businesses, it could show the next available appointment slot. As an example, occupancy sensors such as infrared beams, thermal cameras, or Wi-Fi tracking systems could be installed at entry and exit points to monitor customer flow. These sensors could connect to a local control unit for initial data processing. Simultaneously, the business's point-of-sale (POS) system could be integrated with the status update system via an API, providing real-time access to transaction data, table availability, or appointment bookings. A local processing unit, either a dedicated computer or a module within the existing business system, could aggregate data from both the occupancy sensors and the POS system. This unit could run software to calculate current occupancy percentages, estimate wait times, and determine the next available appointment slots for service-based businesses. This granular level of information could be particularly useful for customers trying to plan their visits and could help businesses manage customer flow more effectively. The system could even allow customers to join a virtual queue or make a reservation directly through the status display interface, creating a seamless connection between status information and customer action.

Therefore, it is expressly disclosed that in addition to or even in place of the example detection techniques mentioned in the claims, alternative detection technologies may be integrated into the business operating status update system to achieve the same ends of registering business status, updating information, and communicating with various platforms related to the status update process. Such implementable alternatives, expressly disclosed as functionally equivalent options fully available for integration in the present business operating status update systems without limitation, include but are not limited to the aforementioned detection means.

Use of these equivalent options for instrumented detection presents equal derivative claim standing per the linked business status detection objectives and system utility improvements. disclosed, regardless of the specific technique elected for implementation in the business operating status update system.

### INDUSTRIAL APPLICATION

The invention described herein finds significant industrial applications across various sectors. In retail, it enables stores to communicate real-time operating hours, improving customer service and foot traffic management. Restaurants can use it to indicate immediate seating availability or kitchen closure times. Service industries, such as banks or post offices, can update customers about branch operating hours or temporary closures. Manufacturing facilities can signal production line status to suppliers and distributors. Healthcare providers can communicate emergency room wait times or clinic availability. Event venues can update attendees about gate openings or early closures. The system's flexibility allows it to be adapted for any industry where communicating operational status is crucial for customer satisfaction and operational efficiency.

What is claimed is:

1. A system for updating and displaying business operating status, comprising:
a signal generation mechanism configured to generate an activation signal indicative of a business operating status;
a data communication network operatively connected to the signal generation mechanism;
at least a server operatively connected to the data communication network and configured to:
receive the activation signal from the signal generation mechanism via the data communication network, update a stored business operating status based on the received activation signal, and
transmit the updated business operating status; and
a data display device operatively connected to the server and configured to:
receive the updated business operating status from the server, and
display the updated business operating status.

2. The system of claim 1, wherein the signal generation mechanism comprises a physical button located at the business premises.

3. The system of claim 1, wherein the signal generation mechanism comprises a virtual button integrated with an Enterprise Resource Planning (ERP) system, configured to:
send an active status signal when the ERP system is in use, indicating the business is open, and
send no signal when the ERP system is not in use, indicating the business is closed.

4. The system of claim 1, wherein the signal generation mechanism comprises a door sensor configured to:
automatically send an open status signal when the door is opened,
and automatically send a closed status signal when the door is closed.

5. The system of claim 1, wherein the signal generation mechanism is further configured to prompt for a closing timeline, allowing input of a predetermined time period before the business status changes to closed.

6. The system of claim 5, wherein the server is further configured to:
initiate a countdown based on the predetermined time period, and
automatically update the business operating status to closed when the countdown reaches zero.

7. The system of claim 1, wherein the data display device comprises a plurality of third-party platforms, each configured to display the updated business operating status.

8. The system of claim 1, wherein the server is further configured to: store scheduled business operating hours;
compare the received activation signal with the scheduled business operating hours, and;
generate a status qualifier based on the comparison, the status qualifier being one of: “open early”, “opened late”, “opening late”, “closing early”, “closing early”, “closed late”, or substantively similar.

9. The system of claim 1, wherein the communication module is configured to transmit the business operating status to an intermediary server, wherein the intermediary server is configured to relay the signal to the one or more remote servers associated with third-party listing websites or applications.

10. A method for updating and displaying business operating status, comprising:
receiving, at a server, an activation signal indicative of a business operating status via a data communication network, wherein the activation signal is generated by a signal generation mechanism selected from a group comprising:
a physical button located at the business premises;
a virtual button integrated with an Enterprise Resource Planning (ERP) system;
a door sensor configured to automatically detect door opening and closing, and;
a software-based activation mechanism on a business computing updating, by the server, a stored business operating status based on the received activation signal;
transmitting, by the server, the updated business operating status to a data display device; and
displaying, by the data display device, the updated business operating status.

11. The method of claim 10, further comprising:
prompting, by the signal generation mechanism, for a closing timeline input;
receiving a predetermined time period for the closing timeline;
initiating a countdown based on the predetermined time period; and
automatically updating the business operating status to closed when the countdown reaches zero.

12. The method of claim 11, further comprising:
storing, at the server, scheduled business operating hours;
comparing the received activation signal with the scheduled business operating hours; and
generating a status qualifier based on the comparison.

13. The method of claim 12, wherein the status qualifier is one of: “open early”, “opened late”, “opening late”, “closing early”, “closing early”, “closed late”, or substantively similar.

14. The method of claim 10, wherein the data display device comprises a plurality of third-party platforms, and the method further comprises transmitting the updated business operating status to each of the plurality of third-party platforms.

15. The method of claim 10, wherein when the signal generation mechanism is the virtual button integrated with the ERP system, the method further comprises:
sending an active status signal when the ERP system is in use, indicating the business is open; and
sending no signal when the ERP system is not in use, indicating the business is closed.

16. The method of claim 10, further comprising:
receiving, by at least one of the one or more remote servers, a request from a customer to follow or subscribe to status updates for a specific business;
storing, by the at least one remote server, customer information and associated business subscription data in a database;
receiving, by the at least one remote server, the status update signal from the signal generation of the specific business;
identifying, by the at least one remote server, customers who have subscribed to status updates for the specific business;
generating, by the at least one remote server, notification messages for the identified customers; and
transmitting, by the at least one remote server, the notification messages to the identified customers, wherein the notification messages include information about the current operating status of the specific business.

17. The method of claim 10, wherein the communication module is configured to transmit the business operating status to an intermediary server, wherein the intermediary server is configured to relay the signal to the one or more remote servers associated with third-party listing websites or applications.

18. A device for displaying and communicating business operating status, comprising:
a housing;
a display area integrated with the housing, the display area configured to alternately show “Open” and “Closed” status, wherein “Closed” status may display the word “Closed” or the word “Open” is no longer glowing, lit, or otherwise indicated as activated, suggesting to those who view the sign the business is no longer open;
a switch mechanism integrated with the housing, the switch mechanism having at least two positions corresponding to “Open” and “Closed” states;
a power interface configured to connect to a power source, wherein the power source is selected from the group consisting of a plug-in electrical connection and a battery;
a control unit disposed within the housing and operatively connected to the switch mechanism and the display area, the control unit configured to change the display area from “Closed” to “Open” or from “Open” to “Closed” in response to actuation of the switch mechanism;
a communication module disposed within the housing and operatively connected to the control unit, the communication module configured to:
establish a wired or wireless connection with one or more remote servers associated with third-party listing websites or applications;
transmit an “Open” signal to the one or more remote servers when the switch mechanism is actuated to the “Open” position;
transmit a “Closed” signal to the one or more remote servers when the switch mechanism is actuated to the “Closed” position;
wherein the device is configured such that actuation of the switch mechanism simultaneously changes the display on the display area and triggers the transmission of the corresponding status signal to the one or more remote servers.

19. The device of claim 18, further comprising a separate control unit housing, wherein the manual switch mechanism is a physical switch integrated with the separate control unit housing and operatively connected to the control unit within the device housing via a wired or wireless connection.

20. The device of claim 18, wherein the manual switch mechanism is a digital toggle implemented as a touchscreen interface or a software button on a connected computing device.

21. The device of claim 18, wherein the communication module is configured to transmit the “Open” or “Closed” signal directly to the one or more remote servers associated with third-party listing websites or applications.

22. The device of claim 18, wherein the communication module is configured to transmit the “Open” or “Closed” signal to an intermediary server, wherein the intermediary server is configured to relay the signal to the one or more remote servers associated with third-party listing websites or applications.

23. A method for acting as an intermediary server to receive a business's operating hours, and/or current operating status, and/or status qualifier message (collectively ‘business information’) and then to relay the business information across a plurality of systems, websites, and apps, including business directories such as Apple Maps, Google Local, and Yelp, business website hosting providers such as Wix, Squarespace, and Shopify, and other websites, apps, and systems with the function of presenting a business's operating status or operating hours to the public, potential or actual customers, and/or to any other system(s) comprising:
receiving business information from a device, physical button, virtual button, or sensors located at the business or directly input by a manager for the business;
optionally updating the stored business information;
sending the business information to any website, app, or system a manager for the business has previously connected and requested be updated when updated business information is received.

24. The method of claim 23 wherein the method of receiving business information involves an API, SDK, or other method of transmitting information between servers.

25. The method of claim 23 where in the method of sending business information involves an API, SDK, or other method of transmitting information between servers.

26. The method of claim 23 wherein the intermediary server crafts the status qualifier message based on the business's current operating status compared to the business's operating hours.

27. The method of claim 23 where the intermediary server may notify a manager of the business if it appears, based on a comparison of the local time to the business's operating hours that a business manager may have forgotten to set the business operating status to Open or Closed.

28. The method of claim 23 wherein a manager for the business can directly input business information directly through an interface provided by the intermediary server, which can override the latest business information provided by a device, physical button, virtual button, or sensors located at the business.
